(19) United States
(12) Patent Application Publication
(10) Pub. No.: US 2009/0158871 A1
(43) Pub. Date: Jun. 25, 2009

(54) Driving Device for an Extendible and Retractable Actuator

(76) Inventor: Yung-Tsai CHUO, Taichung (TW)

Correspondence Address: Dr. BANGER SHIA, 102 Lindencrest Ct., Sugar Land, TX, 77479-5201, US

(21) Appl. No.: 11/961,803

(22) Filed: Dec. 20, 2007

(51) Int. Cl. F16H 3/06

(52) U.S. Cl. 74/89.35

(57) ABSTRACT

A driving device for an extendible and retractable actuator comprises a first rod, a second rod, a third rod and a motor. The first rod is screwed with the second rod. The second rod is screwed with the third rod. By such arrangements, the motor can drive the first and the second rods to move while driving the third rod to rotate. After the third rod is engaged with the second rod, the first rod can be also driven to move.

### BACKGROUND OF THE INVENTION

1. Field of the Invention

The present invention relates to a driving device, and more particularly to a driving device for an extendible and retractable actuator.

2. Description of the Prior Art

An actuator has a quite wide application range and generally utilizes an inner motor to automatically extend/retract to actuate other components. A conventional actuator disclosed in U.S. Pat. No. 6,880,416 comprises a three-section extension sleeve, a motor disposed in the extension sleeve and three screw shafts. The three screw shafts are connected with the respective sleeves of the extension sleeve, respectively. The motor drives the three screw shafts to move in the axial direction, so that the extension sleeve can be driven to extend/retract.

Another conventional actuator disclosed in EP. Pat. No. 0,982,018 comprises a motor, a screw shaft and a pulley that are disposed in a three-section extension sleeve. The motor drives the screw shaft to rotate, then the screw shaft drives the sleeve disposed with the pulley to move, and then the pulley drives the other sleeve to move. Thereby, the extension sleeve is driven to extend/retract.

After many years of researching on the actuator, the applicant of the present invention has developed a driving device for a screw shaft-driving type actuator.

### SUMMARY OF THE INVENTION

The primary objective of the present invention is to provide a driving device which drives an extendible and retractable actuator to extend/retract by screwing screw shafts.

In order to achieve the above objective, the driving device in accordance with the present invention comprises a first rod, a second rod, a third rod and a motor. The first rod and the second rod are hollow, and one end of each of the first rod and the second rod is opened. Both the first rod and the second rod are disposed with a plurality of studs inside their open ends. The second rod includes an outer thread outside thereof, and the second rod is screwed to the studs inside of the open end of the first rod by use of the outer thread thereof. The third rod includes an outer thread outside thereof, and the third rod is screwed to the studs inside the open end of the second rod by use the outer thread thereof.

The motor drives the third rod to rotate. The third rod is rotated with respect to the second rod to drive the second rod to move in the axial direction. When the friction force between the third rod and the second rod is greater than the friction force between the second rod and the first rod, the third rod will drive the second rod to rotate to make the second rod rotate with respect to the first rod to drive the first rod to move in the axial direction.

### BRIEF DESCRIPTION OF THE DRAWINGS

FIG. 1 is a schematic view of a driving device for an extendible and retractable actuator in accordance with the present invention;

FIG. 2 is a transverse cross sectional view showing that a first rod is being screwed with a second rod in accordance with the present invention;

FIG. 3 is a transverse cross sectional view showing that a first rod is being screwed with a second rod in accordance with the present invention;

FIG. 4 is a schematic view illustrating how the motor is drivingly connected to the third rod in accordance with the present invention; and

FIG. 5 is a schematic view of another driving device for an extendible and retractable actuator whose first rod and second rod are not disposed with inner threads in accordance with the present invention.

### DETAILED DESCRIPTION OF THE PREFERRED EMBODIMENTS

The present invention will be clearer from the following description when viewed together with the accompanying drawings, which show, for purpose of illustrations only, the preferred embodiment in accordance with the present invention.

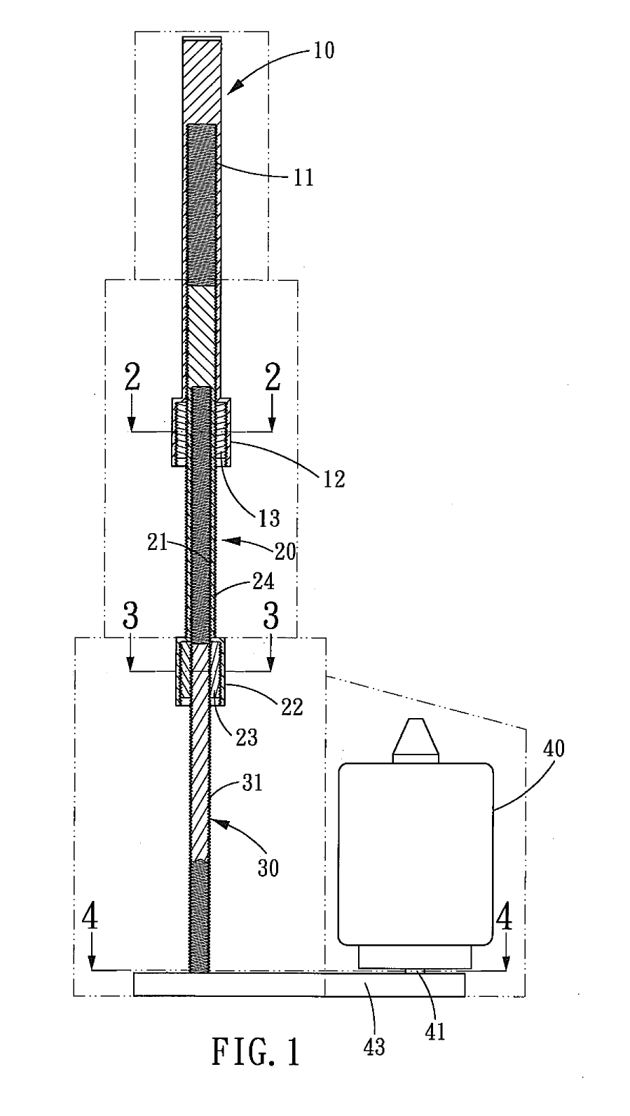

Referring to FIGS. 1-4, a driving device for an extendible and retractable actuator in accordance with the present invention comprises a first rod 10, a second rod 20, a third rod 30, and a motor 40.

The first rod 10 is hollow inside and includes an inner thread 11. The first rod 10 is opened towards one end 12. This end 12 is radially expanded and includes four studs 13 inside thereof. The four studs 13 are equidistantly arranged and coaxially disposed with respect to the first rod 10. Each stud 13 is formed with an outer thread for engaging with the inner thread 11. These studs 13 in the present embodiment are fixed inside the end 12.

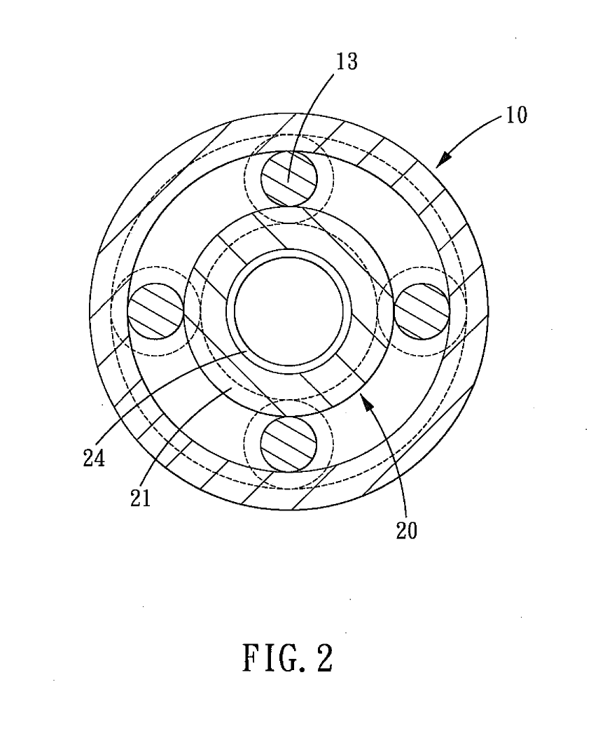

The second rod 20 is hollow inside and includes an inner thread 21. The second rod 20 is opened towards one end 22. The end 22 is radially expanded and includes four studs 23 inside thereof. The four studs 23 are equidistantly arranged and coaxially disposed with respect to the second rod 20. Each stud 23 is formed with an outer thread for engaging with the inner thread 21. These studs 23 in the present embodiment are fixed inside the end 22. The second rod 20 includes an outer thread 24 outside thereof. As shown in FIG. 2, the other end of the second rod 20 is screwed to the four studs 13 and the inner thread 11 of the first rod 10 by use of the outer thread 24, so that when the second rod 20 is rotated with respect to the first rod 10, the first rod 10 and the second rod can move in the axial direction.

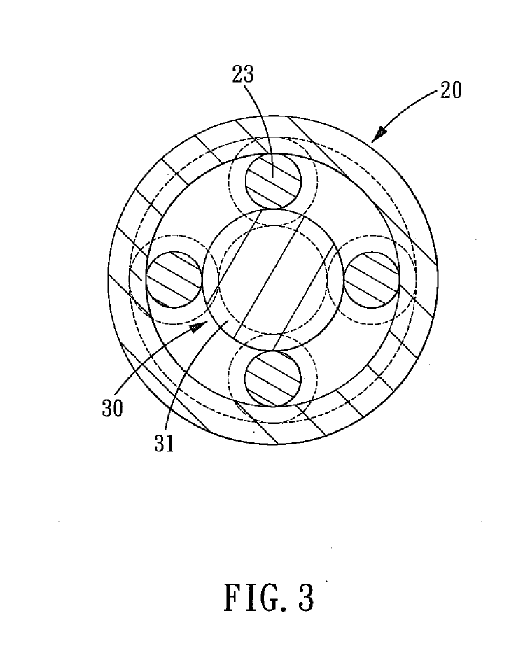

The third rod 30 includes an outer thread 31 outside thereof. As shown in FIG. 3, one end of the third rod 30 is screwed to the four studs 23 and the inner thread 21 of the second rods 20 by the outer thread 31, and the other end of the third rod 30 is coaxially disposed with a gear 32, so that when the third rod 30 rotates with respect to the second rod 20, the second rod 20 and the third rod 20 can move in the axial direction.

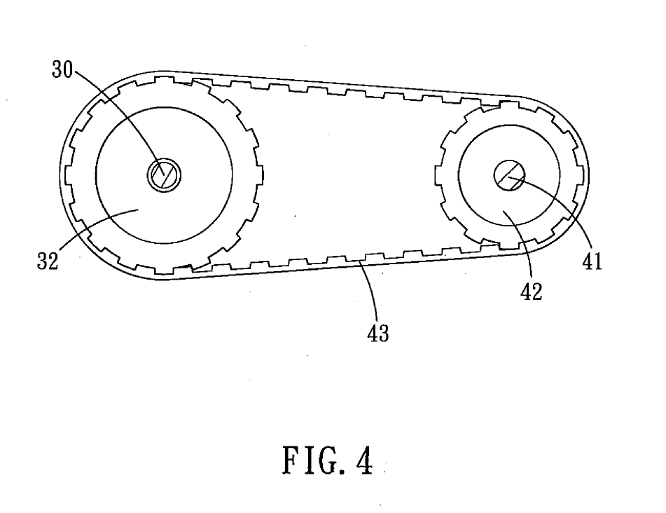

The motor 40 includes a rotary shaft 41 which is coaxially disposed with a driving gear 42. The driving gear 42 is wound with a belt 43. The belt 43 is also wound around the third rod 30, so that the motor 40 is drivingly connected with the third rod 30, as shown in FIG. 4.

When the rotary shaft 41 of the motor 40 is driven to rotate, the driving gear 42 of the motor 40 will simultaneously rotate to drive the gear 32 of the third rod 30 by use of the belt 43, thus rotating the third rod 30. The third rod 30 will rotate with respect to the second rod to drive the second rod 20 and the first rod 10 to move in the axial direction.

When the friction force between the third rod 30 and the second rod 20 is greater than the friction force between the second rod 20 and the first rod 10 (for example, the third rod 30 is engaged with the second rod 20), the third rod 30 will drive the second rod 20 to rotate, so that the second rod 20 will rotate with respect to the first rod 10, and the first rod 41 is driven to move in the axial direction.

Hence, as long as the three rods 10, 20, 30 are respectively fixed on the parts of the extendible and retractable actuator to be extended, the extendible and retractable actuator can be driven to extend. Moreover, as long as the first rod 10 includes an outer thread outside thereof, and a rod body configured similar to the first rod 10 is used to be screwed outside the first rod 10, the driving device can continue extending for suiting for the extendible and retractable actuator with more extension parts. Since there is almost no difference between the extending structure and the structure in accordance with the present invention, the detailed explanations are omitted here. The studs 13, 23 can also be rotatably disposed in the first rod 10 and the second rod 20 and can simultaneously rotate and move when the driving device is actuated.

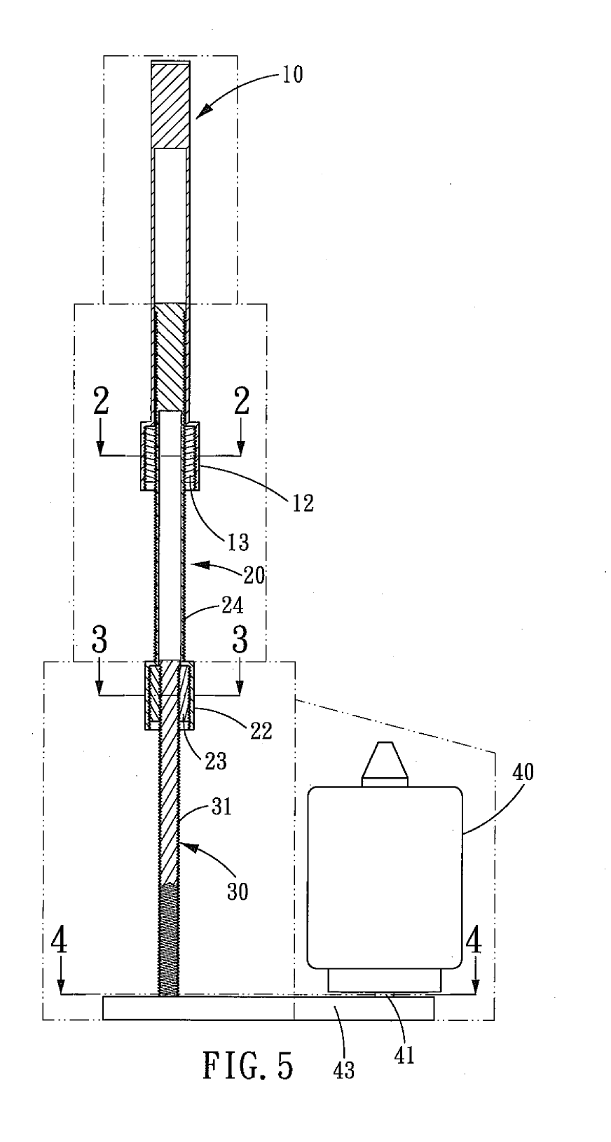

In addition, the driving device can be also as shown in FIG. 5. The first rod 10 and the second rod don't include the inner threads 11, 21. The outer thread 24 of the second rod 20 is screwed with the four studs 13 of the first rod 10, and the outer thread 31 of the third rod 30 is screwed with the four studs 23 of the second rod 20. By such arrangements, the motor 40 also can drive the first rod 10 and the second rod 20 to move in the axial direction, achieving the extension function.

While we have shown and described various embodiments in accordance with the present invention, it is clear to those skilled in the art that further embodiments may be made without departing from the scope of the present invention.

What is claimed is:

1. A driving device for an extendible and retractable actuator comprising:
a first rod being hollow inside and opened towards one end thereof, the first rod being disposed with a plurality of studs inside the open end thereof;
a second rod is hollow inside and opened towards one end thereof, the second rod being disposed with a plurality of studs inside the open end thereof, the second rod further including an outer thread outside thereof, the second rod being screwed to the studs of the first rod by use of the outer thread thereof;
a third rod including an outer thread outside thereof, the third rod being screwed to the studs of the second rod by use of the outer thread thereof; and
a motor being drivingly connected with the third rod.

2. The driving device for an extendible and retractable actuator as claimed in claim 1, wherein the first rod includes an inner thread, and the second rod is screwed to the studs and the inner thread of the first rod by use of the outer thread thereof.

3. The driving device for an extendible and retractable actuator as claimed in claim 1, wherein the second rod includes an inner thread, and the third rod is screwed to the studs and the inner thread of the second rod by use of the outer thread thereof.

4. The driving device for an extendible and retractable actuator as claimed in claim 1, wherein the third rod is coaxially disposed with a gear, and a rotary shaft of the motor is also coaxially disposed with a driving gear, the driving gear is wound with a belt, and the belt is also wound around the gear of the third rod, so that the motor is drivingly connected with the third rod.

5. The driving device for an extendible and retractable actuator as claimed in claim 1, wherein the studs of the first rod are fixed inside the open end of the first rod, and the studs of the second rod are fixed inside the open end of the second rod.

6. The driving device for an extendible and retractable actuator as claimed in claim 1, wherein the open end of the first rod is radially expanded, and the studs of the first rod are disposed inside the open end of the first rod and coaxially disposed with the first rod, the studs of the first rod are equidistantly arranged.

7. The driving device for an extendible and retractable actuator as claimed in claim 1, wherein the first rod includes an inner thread, the open end of the first rod is radially expanded, the studs of the first rod are disposed inside the open end of the first rod and coaxially disposed with the first rod, the studs of the first rod are equidistantly arranged, each stud of the first rod is formed with an outer thread for engaging with the inner thread of the first rod, the second rod is screwed to the studs and the inner thread of the first rod by use of the outer thread thereof.

8. The driving device for an extendible and retractable actuator as claimed in claim 1, wherein the open end of the second rod is radially expanded, and the studs of the second rod are disposed inside the open end of the second rod and are coaxially disposed with the second rod, the studs of the second rod are equidistantly arranged.

9. The driving device for an extendible and retractable actuator as claimed in claim 1, wherein the second rod includes an inner thread, and the open end of the second rod is radially expanded, the studs of the second rod are disposed in the open end of the second rod and coaxially disposed with the second rod, the studs of the second rod are equidistantly arranged, each stud of the second rod is formed with an outer thread for engaging with the inner thread of the second rod, the third rod is screwed to the studs and the inner thread of the second rod by use of the outer thread thereof.
